(19) United States
(12) Patent Application Publication
(10) Pub. No.: US 2012/0105285 A1
(43) Pub. Date: May 3, 2012

(54) APPARATUS AND METHOD FOR ESTIMATING ANGLE OF ARRIVAL IN REAL TIME

(75) Inventors: Kyung Hwan Park, Daejeon (KR); Sung Weon Kang, Daejeon (KR); Seok Bong Hyun, Daejeon (KR); Tae Young Kang, Daejeon (KR); Byoung Gun Choi, Daegu (KR); Chang Hee Hyoung, Daejeon (KR); Jung Hwan Hwang, Daejeon (KR); Sung Eun Kim, Seoul (KR)

(73) Assignee: Electronics and Telecommunications Research Institute, Daejeon (KR)

(21) Appl. No.: 13/267,223

(22) Filed: Oct. 6, 2011

(30) Foreign Application Priority Data
Oct. 29, 2010 (KR) 10-2010-0107024

(51) Int. Cl. G01S 3/02

(52) U.S. Cl. 342/417

(57) ABSTRACT

An apparatus for estimating an angle of arrival includes: a plurality of direction synthesizing units shifting the phase of each of a plurality of signals received by an array antenna such that the angle of arrival of each of the received signals is changed by a predetermined change angle; and an estimation unit estimating the angle of arrival of the received signal by using radiation gains of two phase-shifted signals among the signals phase-shifted by the plurality of direction synthesizing units.

### CROSS-REFERENCE TO RELATED APPLICATIONS

This application claims the priority of Korean Patent Application No. 10-2010-0107024 filed on Oct. 29, 2010, in the Korean Intellectual Property Office, the disclosure of which is incorporated herein by reference.

### BACKGROUND OF THE INVENTION

1. Field of the Invention

The present invention relates to an apparatus and method for estimating an angle of arrival in real time, and more particularly, to an apparatus and method for estimating an angle of arrival capable of detecting the direction of a signal received from an array antenna in a wireless communication system or a radar system in real time.

The present invention is derived from research conducted as a part of IT growth power industrial technology development work supported by the IT R&D program of MIC/IITA and the Knowledge Economics Department [Project Management No.: 2009-S-025-01, Project title: Development of 60 GHz CMOS Beam Forming Common Platform Technique]

2. Description of the Related Art

In the case of conventional wireless communications systems, a great deal of directional antenna techniques or beamforming techniques for increasing the gain of antennas in a particular direction have been developed to secure as many communications channels as possible within limited radio resources or to enhance transmission/reception power efficiency.

However, in the case of the directional beamforming, in order to enhance transmission/reception efficiency, the direction of received radio waves and the direction in which a radiation gain of beams is maximized must be consistent with each other. Such beamforming is largely implemented by using an array antenna, so various direction detection methods using the array antenna have been proposed.

A typical method is shifting the phase of each antenna element of the array antenna to search in every direction, and estimating a direction in which a strongest signal is captured as a signal arrival direction. In this case, an analog phase shifter or a digital phase shifter is used to generate phase shifting.

When the digital phase shifter is used, various types of independent beamforming can be possibly performed, but when a usable frequency is increased, high speed digital processing is required, so the analog phase shifter is mainly used in a millimeter wave band. Also, the techniques have a limitation in that a considerable amount of time is required to detect directions.

Thus, an apparatus for estimating an angle of arrival in real time, capable of reducing a search process while using the analog shifter in order to implement an effective beamforming technique in a millimeter wave band is required.

### SUMMARY OF THE INVENTION

An aspect of the present invention provides a method and apparatus for reducing a search process and estimating an arrival direction in real time.

According to an aspect of the present invention, there is provided an apparatus for estimating an angle of arrival, including: a plurality of direction synthesizing units shifting the phase of each of a plurality of signals received by an array antenna, such that the angle of arrival of each of the received signals is changed by a predetermined change angle; and an estimation unit estimating the angle of arrival of the received signal by using radiation gains of two phase-shifted signals among the signals phase-shifted by the plurality of direction synthesizing units.

According to another aspect of the present invention, there is provided a system for receiving an RF signal, including: an array antenna; an arrival angle estimation apparatus including a plurality of direction synthesizing units shifting the phase of each of signals received by an array antenna such that the angle of arrival of each of the received signals is changed by a predetermined change angle, and an estimation unit estimating the angle of arrival of the received signal by using radiation gains of two phase-shifted signals among the signals phase-shifted by the plurality of direction synthesizing units; and a branch device for branching the signals received by the array antenna to the arrival angle estimation apparatus.

According to another aspect of the present invention, there is provided a method for estimating an angle of arrival, including: a direction synthesizing step of shifting the phase of each of a plurality of signals received by an array antenna such that the angle of arrival of each of the received signals is changed by a predetermined change angle; and an estimation step of estimating the angle of arrival of the received signal by using radiation gains of two phase-shifted signals among a plurality of phase-shifted signals obtained by performing the plurality of direction synthesizing steps for a plurality of times or in parallel.

According to another aspect of the present invention, there is provided a method for estimating an angle of arrival, including: a direction synthesizing step of shifting the phase of each of signals received by an array antenna such that the angle of arrival of each of the received signals is changed by a predetermined change angle; an estimation step of selecting three or more signals among the plurality of phase-shifted signals obtained by performing the plurality of direction synthesizing steps for a plurality of times or in parallel and then estimating the angle of arrival of the received signal by using radiation gains of two phase-shifted signals; and averaging a plurality of angles of arrival obtained by performing the estimation step by differentiating one or more of the two signals to determine an angle of arrival of the received signal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a function block diagram of the entire configuration of an apparatus for estimating an angle of arrival according to an exemplary embodiment of the present invention;

FIG. 2 is a function block diagram of an estimation unit of the apparatus for estimating an angle of arrival according to an exemplary embodiment of the present invention;

FIGS. 3A and 3B are diagrams illustrating the effect of phase shifting in a direction synthesizing unit;

FIG. 4 is a diagram illustrating the process of searching for an estimated angle of arrival by using radiation gain pattern values stored in a storage unit;

FIG. 5 is a schematic view of a wireless communication system including an apparatus for estimating an angle of arrival according to an exemplary embodiment of the present invention; and

FIG. 6 is a flow chart illustrating the process of a method for estimating an angle of arrival according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

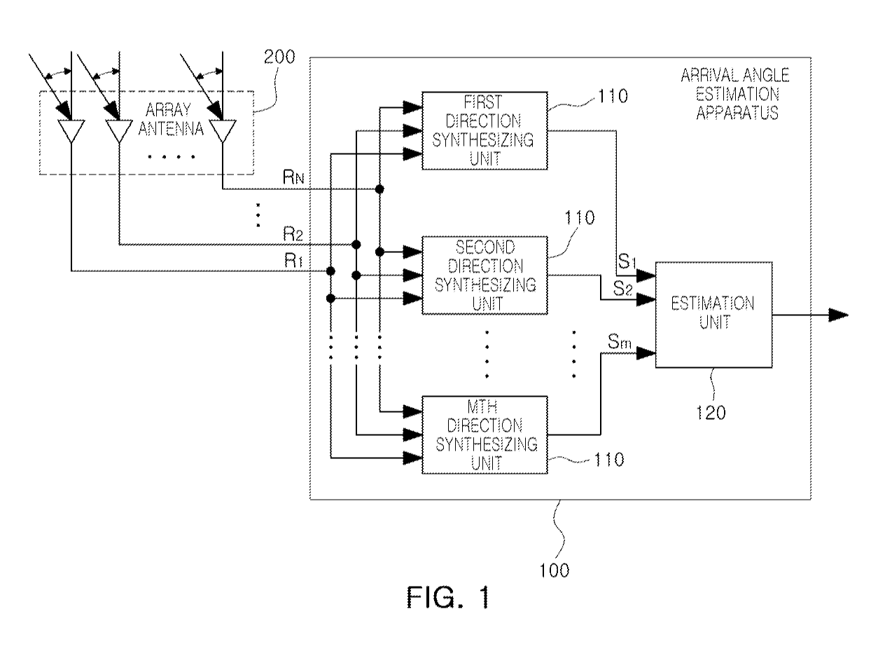

FIG. 1 is a function block diagram of the entire configuration of an apparatus 100 for estimating an angle of arrival according to an exemplary embodiment of the present invention.

With reference to FIG. 1, the apparatus 100 for estimating an angle of arrival according to an exemplary embodiment of the present invention may include a plurality of direction synthesizing units 110 and an estimation unit 120.

The direction synthesizing units 110 phase-shift and synthesize signals received by respective antenna elements of an antenna array. Here, the phase-shifting is differentially performed on the signals received by the respective antenna elements such that angles of arrival of the received signals are changed by a certain angle. Also synthesizing is performed by adding the phase-shifted signals.

For example, when it is assumed that a radio signal is s(r)=Ar^{jkr} (which is expressed only by space variables, A is the amplitude of signal, k is a wave number, and r is the distance from a source), and an angle of arrival (an incident angle based on a vertical array plane) of a signal received by the array antenna is θ, and the distance between the antenna elements is D, then, signals R1 to RN received by the respective antenna elements can be represented as follows:

$$First antenna element \text{:} {R}_{1} = A {e}^{j kr}$$

$$Second antenna element \text{:} \begin{matrix}{R}_{2} = A {e}^{j kr} {e}^{j kd} \\ ⋮\end{matrix}$$

$$Nth antenna element \text{:} \begin{matrix}{R}_{N} = A {e}^{j kr} {d}^{j ( N - 1 ) kd} \\ d = D sin θ\end{matrix}$$

When the direction synthesizing unit changes the angles of arrival by θ₁, the phase-shifted signals (S1: S11 to S1N) are as follows:

$$First antenna element \text{:} {S}_{11} = A {e}^{j kr}$$

$$Second antenna element \text{:} \begin{matrix}{S}_{12} = A {e}^{j kr} {e}^{j kd} {e}^{j {kd}_{1}} \\ ⋮\end{matrix}$$

$$Nth antenna element \text{:} {S}_{1 N} = A {e}^{j kr} {e}^{j ( N - 1 ) kd} {e}^{j ( N - 1 ) {kd}_{1}}$$

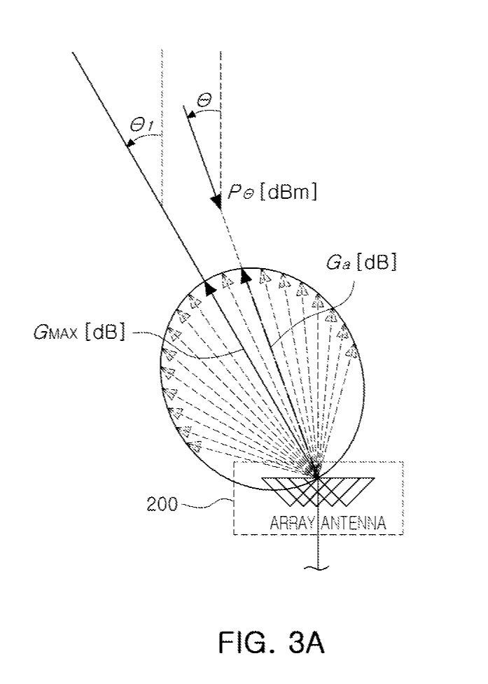

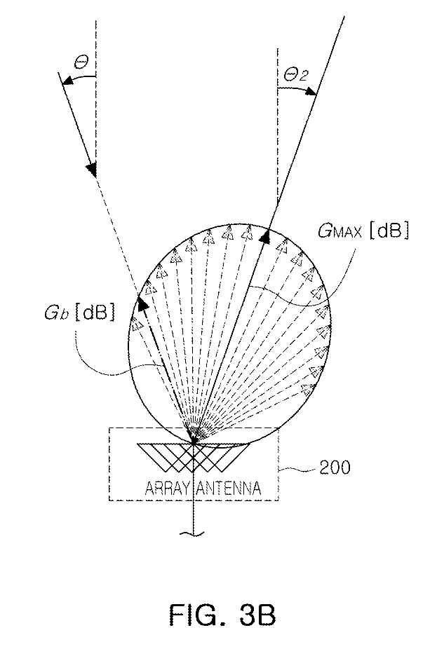

FIG. 3A shows the effect of the phase shifting.

When the phase-shifted signals are added,

s₁=Ae^{jkr}[1+e^{jk(d+d}^{₁}⁾+e^{j2k(d+d}^{₁}⁾+ . . . +e^{j(N-1)k(d+d}^{₁}⁾]

When a different direction synthesizing unit changes the angle of arrival by θ₂, the phase-shifted signals (S2: S21 to S2N) are as follows:

$$First antenna element \text{:} {S}_{21} = A {e}^{j kr}$$

$$Second antenna element \text{:} \begin{matrix}{S}_{22} = A {e}^{j kr} {e}^{j kd} {e}^{j {kd}_{2}} \\ ⋮\end{matrix}$$

$$Nth antenna element \text{:} \begin{matrix}{S}_{2 N } = A {e}^{j kr} {e}^{j ( N - 1 ) kd} {e}^{j ( N - 1 ) {kd}_{1}} \\ {d}_{2} = D sin {θ}_{2}\end{matrix}$$

FIG. 3B schematically shows the effect of the phase shifting.

When the phase-shifted signals are added,

s₂=Ae^{jkr}[1+e^{jk(d+d}^{₂}⁾+e^{j2k(d+d}^{₂}⁾+ . . . +e^{j(N-1)k(d+d}^{₂}⁾]

The direction synthesizing units may be implemented to include a path delay circuit for the phase shifting, respectively. The path delay circuit may be implemented as an analog circuit, as well as as a digital circuit. When the path delay circuit is implemented as an analog circuit, the apparatus for estimating an angle of arrival does not have a problem with a processing speed even in a millimeter wave band.

The estimation unit 120 estimates an angle of arrival by using a radiation gain of output signals from the plurality of direction synthesizing unit 110.

The estimation unit 120 determines an angle of arrival of each of the reception signals by using angles of arrival having a radiation gain belonging to a certain range based on a subtraction value of radiation gains of two signals among the output signals from the direction synthesizing units 110.

Namely, the angles of arrival can be simply estimated by using only the reception signals without having to search for the entire angles by using the estimation unit 120.

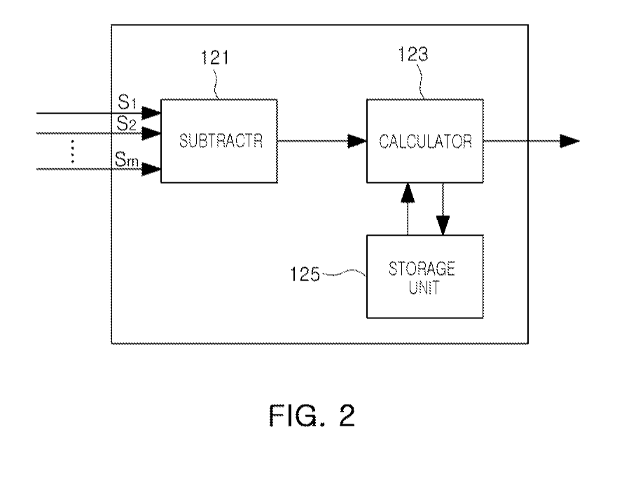

FIG. 2 is a function block diagram of the estimation unit of the apparatus for estimating an angle of arrival according to an exemplary embodiment of the present invention.

With reference to FIG. 2, the estimation unit 120 according to an exemplary embodiment of the present invention may include a subtractor 121 and a calculator 123. The estimation unit 120 may further include a storage unit 125.

The subtractor 121 generates a subtraction value of power of the respective signals by selecting two signals from among the plurality of synthesized signals received from the plurality of direction synthesizing units 110. The subtraction value of the power is the difference of radiation gains of the selected two signals.

For example, when the power values of s₁ and s₂ are Pₐ and P_{b}, Pₐ=10 log₁₀[|s₁|²] and P_{b}=10 log₁₀[|s₂|²].

When the radiation gains Gₐ and G_{b} are Gₐ=G(θ₁−θ) and G_{b}=G(θ₂−θ), respectively, the subtraction value of the power values and the subtraction value of the radiation gains have the following relationship:

$$\begin{matrix}{P}_{a} - {P}_{b} = ( {P}_{0} + {G}_{a} ) - ( {P}_{0} + {G}_{b} ) \\ = {G}_{a} - {G}_{b} \\ = {G}_{ab}\end{matrix}$$

$${P}_{0} = 10 {log}_{10} [ {\vert {R}_{1} \vert}^{2} ]$$

Namely, only the subtraction value of the pure radiation gains can be extracted through the subtraction of the power values of the reception signal of the respective antenna elements.

The calculator 123 compares the subtraction value of the power obtained by the subtractor with a subtraction value between a radiation gain of an estimated angle of arrival and a radiation gain of an angle obtained by subtracting a change angle from the estimated angle of arrival, and when the subtraction value of the power obtained by the subtractor is within a certain range, the calculator 123 determines the angle of arrival of the signals received by the array antenna by using the estimated angle of arrival.

For example, in the process of comparing the radiation gain with respect to the estimated angle of arrival and the radiation gain obtained by using the subtractor, it is assumed that a particular angle of arrival is θₒ and the estimated angle of arrival is α=θ₁−θ₀.

And, when θₒ satisfying G(α)−G(α−Δθ)=G_{ab} and (Δθ=θ₁−θ₂) are found, θₒ is an angle of arrival of the reception signal.

In this case,

In order to facilitate calculation, radiation gains (radiation patterns) with respect to the entire range of the angles of arrival with respect to the corresponding array antenna may be obtained and stored in the storage unit 125. Namely, the storage unit 125 stores unique radiation gain patterns of the array antenna.

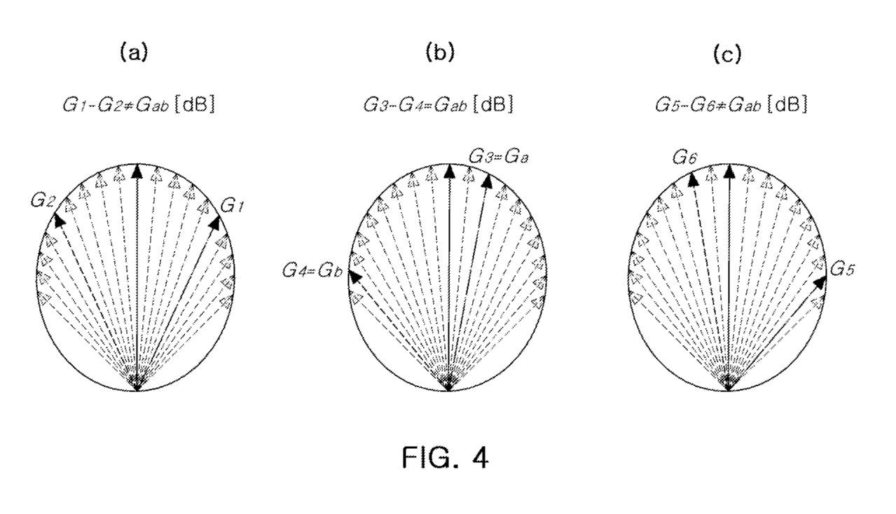

With reference to FIG. 4, the process of searching for G(α)−G(α−Δθ)=G_{ab} by using a radiation gain pattern value stored in the storage unit 125 is schematically shown.

If the values θ₁ and θ₂ are previously determined, the value G(α)−G(α−Δθ) with respect to the estimated angle of arrival α may be previously calculated and stored in the storage unit 125.

The calculator 123 may store history of estimating the angle of arrival in the storage unit 125, and when a similar G_{ab}, or a value of a synthesized signal is input, the calculator 123 may check the history and immediately output the information regarding the angle of arrival without performing a calculation and comparison process.

When the calculator 123 estimates an angle of arrival through a comparison with the stored data values, in order for the stored data values and G_{ab} to be precisely consistent with each other, there must be stored data values regarding angles of arrival at sufficiently small intervals. However, in most cases, an angle of arrival may be sufficiently within a certain tolerance. Thus, stored data are formed within the range not exceeding the corresponding tolerance, and when a value is consistent with the stored data within the tolerance in its comparison, it is determined as an angle of arrival.

In this manner, unlike the related art arrival angle estimation apparatus, in the apparatus 100 for estimating an angle of arrival, an angle of arrival can be estimated without having to search for the entire angles. Also, since an angle of arrival can be simply estimated through signal subtraction and comparison without performing complicated digital signal processing such as matrix calculation, or the like, time required for estimating the angle of arrival can be significantly reduced. In addition, since a calculation method is easy, hardware required for data processing does not need to have high performance, and thus, a unit cost in terms of hardware implementation can be lowered.

Also, since a signal is processed in an analog circuit, it can be used for a millimeter wave band.

Although not shown, when three mutual subtraction values (1−2, 2−3, 1−3) of the radiation gains of three signals among output signals from the direction synthesizing units 110 may be compared with the respective radiation patterns stored in the estimation unit to obtain three items of data with respect to the angles of arrival, whereby the angles of arrival can be more accurately estimated. In particular, when fading is severe, or when a channel environment is poor, the angle of arrival can be more accurately estimated by using a larger number of signals as described above.

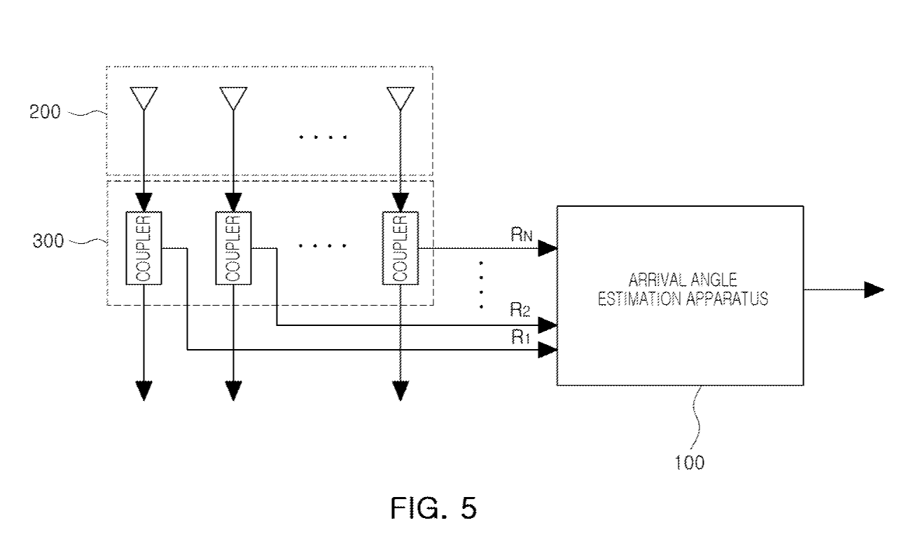

FIG. 5 is a schematic view of a wireless communication system including an apparatus for estimating an angle of arrival according to an exemplary embodiment of the present invention.

With reference to FIG. 5, a wireless communication system may be configured to include the apparatus for estimating an angle of arrival (referred as an ‘arrival angle estimation apparatus 100′, hereinafter), an array antenna 200, and a branch device 300.

The array antenna 200 is a device for transmitting and receiving radio waves, and the branch device 300 is a device for branching a signal received from the array antenna to the arrival angle estimation apparatus 100.

Although not shown, arrival angle information, an output from the arrival angle estimation apparatus 100, may be transmitted to a device for adjusting beamforming of the array antenna and used to make an angle of arrival and a beam direction consistent with each other.

The array antenna 200 is required to include at least two antenna elements.

The branch device 300 may be implemented to include a directional coupler in order to minimize distortion and a loss of a signal in the process of branching a signal.

With reference to FIG. 1, the arrival angle estimation apparatus 100 includes the direction synthesizing units 110 and the estimation unit 120.

Details of the direction synthesizing units 110 and the estimation unit 120 have been described, so a repeated description thereof will be omitted.

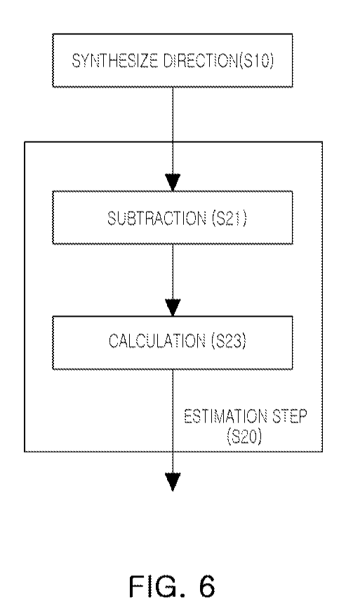

FIG. 6 is a flow chart illustrating the process of a method for estimating an angle of arrival according to an exemplary embodiment of the present invention.

With reference to FIG. 6, the method for estimating an angle of arrival according to an exemplary embodiment of the present invention may include a direction synthesizing step (S10) and an estimation step (S20). The estimation step (S20) may include a subtraction process (S21) and a calculation process (S23).

In the direction synthesizing step (S10), the phase of each of signals received by an array antenna is phase-shifted such that the angle of arrival of each of the received signals is changed by two or more predetermined change angles. Here, the phase-shifting is differentially performed on the signals received by the respective antenna elements such that angles of arrival of the received signals are changed by a certain angle. Also synthesizing is performed by adding the phase-shifted signals.

FIGS. 3A and 3B schematically show the effect of phase shifting.

In the estimation step (S20), an angle of arrival is estimated by using the radiation gain of the synthesized signal generated in the direction synthesizing step (S10).

In the estimation step (S20), an angle of arrival of each of the reception signals is determined by using angles of arrival having a radiation gain belonging to a certain range based on a subtraction value of radiation gains of two signals among the output signals from the direction synthesizing step (S10).

In the subtraction process (S21), a subtraction value of power of the respective signals is generated by selecting two signals from among the plurality of synthesized signals generated in the direction synthesizing step (S10). The subtraction value of the power is the difference of radiation gains of the selected two signals.

In the calculation process (S23), the subtraction value of the power obtained in the subtraction process (S21) is compared with a subtraction value between a radiation gain of an estimated angle of arrival and a radiation gain of an angle obtained by subtracting a change angle from the estimated angle of arrival, and when the subtraction value of the power obtained in the subtraction operation is within a certain range. the angle of arrival of the signal received by the array antenna is determined by using the estimated angle of arrival.

In the calculation process (S23), the radiation gain values regarding the entire angles of arrival of the array antenna may be previously calculated and stored as a database, so as to be used as necessary.

As set forth above, according to exemplary embodiments of the invention, an angle of arrival can be estimated without having to search for all possible angles, and since an angle of arrival can be simply estimated through signal subtraction and comparison without performing complicated digital signal processing such as matrix calculation, or the like, the time required for estimating the angle of arrival can be significantly reduced. Also, since a signal is processed in an analog circuit, it can be within a millimeter wave band. In addition, since a calculation method is simplified, hardware required for data processing does not need to have high performance, and thus, unit cost in terms of hardware implementation can be lowered.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for estimating an angle of arrival, the apparatus comprising:
a plurality of direction synthesizing units shifting the phase of each of a plurality of signals received by an array antenna, such that the angle of arrival of each of the received signals is changed by a predetermined change angle; and
an estimation unit estimating the angle of arrival of the received signal by using radiation gains of two phase-shifted signals among the signals phase-shifted by the plurality of direction synthesizing units.

2. The apparatus of claim 1, wherein the plurality of direction synthesizing units have change angles which are different from each other.

3. The apparatus of claim 2, wherein the estimation unit comprises:
a subtractor selecting two signals from among the signals phase-shifted in the plurality of direction synthesizing units and obtaining a subtraction value from between the powers of the selected signals; and
a calculator comparing the subtraction value of the power obtained by the subtractor with a subtraction value derived from subtracting a radiation gain of an estimated angle of arrival and a radiation gain of an angle obtained by subtracting a subtraction angle from the estimated angle of arrival or vice versa, and determining the angle of arrival of the signal received by the array antenna by using the estimated angle of arrival thereof, when the subtraction value of the power obtained by the subtractor is within a certain range.

4. The apparatus of claim 3, wherein the subtraction value between the change angles of the two selected signals is the subtraction angle.

5. The apparatus of claim 1, wherein the estimation unit further comprises a storage unit storing values obtained by calculating the radiation gains of the overall range of angles of arrival of the array antenna.

6. The apparatus of claim 1, wherein the direction synthesizing units comprise a path delay circuit for shifting the phase of signals received by the array antenna.

7. A system for receiving an RF signal, the system comprising:
an array antenna;
an arrival angle estimation apparatus including a plurality of direction synthesizing units shifting the phase of each of a plurality of signals received by an array antenna such that the angle of arrival of each of the received signals is changed by a predetermined change angle, and an estimation unit estimating the angle of arrival of the received signal by using radiation gains of two phase-shifted signals among the signals phase-shifted by the plurality of direction synthesizing units; and
a branch device for branching the signals received by the array antenna to the arrival angle estimation apparatus.

8. The system of claim 7, wherein the plurality of direction synthesizing units have change angles which are different from each other.

9. The system of claim 7, wherein the estimation unit comprises:
a subtractor selecting two signals from among the signals phase-shifted in the plurality of direction synthesizing units and obtaining a subtraction value from between powers of the selected signals; and
a calculator comparing the subtraction value of the power obtained by the subtractor with a subtraction value derived from subtracting a radiation gain of an estimated angle of arrival and a radiation gain of an angle obtained by subtracting a subtraction angle from the estimated angle of arrival or vice versa, and determining the angle of arrival of the signal received by the array antenna by using the estimated angle of arrival thereof, when the subtraction value of the power obtained by the subtractor is within a certain range.

10. The system of claim 9, wherein the subtraction value between the change angles of the two selected signals is the subtraction angle.

11. The system of claim 7, wherein the estimation unit further comprises a storage unit storing values obtained by calculating the radiation gains of the overall range of angles of arrival of the array antenna.

12. The system of claim 7, wherein the direction synthesizing units comprise a path delay circuit for shifting the phase of signals received by the array antenna.

13. The system of claim 7, wherein the branch device is a directional coupler.

14. A method for estimating an angle of arrival, the method comprising:
a direction synthesizing operation of shifting the phase of each of signals received by an array antenna such that the angle of arrival of each of the received signals is changed by a predetermined change angle; and
an estimation operation of estimating the angle of arrival of the received signal by using radiation gains of two phase-shifted signals among a plurality of phase-shifted signals obtained by performing the plurality of direction synthesizing operations for a plurality of times or in parallel.

15. The method of claim 14, wherein the estimation operation comprises:
a subtraction operation of obtaining a power subtraction value obtained by subtracting a power of the two phase-shifted signals; and
a calculation operation of comparing the subtraction value of the power obtained in the subtraction operation with a subtraction value derived from subtracting a radiation gain of an estimated angle of arrival and a radiation gain of an angle obtained by subtracting a subtraction angle from the estimated angle of arrival or vice versa, and determining the angle of arrival of the signal received by the array antenna by using the estimated angle of arrival, when the subtraction value of the power obtained in the subtraction operation is within a certain range.

16. The method of claim 14, wherein, in the estimation operation, the radiation gain values regarding the entire range of the angle of arrival of the array antenna are previously calculated and stored as a database, and then used when the radiation gain is obtained.

17. The method of claim 14, wherein when the direction synthesizing operation is performed a plurality of times, the change angle is different each time, and when the direction synthesizing operation is performed in parallel, each of the change angles of the direction synthesizing operations is different.

18. A method for estimating an angle of arrival, the method comprising:
a direction synthesizing operation of shifting the phase of each of signals received by an array antenna such that the angle of arrival of each of the received signals is changed by a predetermined change angle;
an estimation operation of selecting three or more signals among the plurality of phase-shifted signals obtained by performing the plurality of direction synthesizing operations for a plurality of times or in parallel and then estimating the angle of arrival of the received signal by using radiation gains of two phase-shifted signals; and
averaging a plurality of angles of arrival obtained by performing the estimation operation by differentiating one or more of the two signals to determine an angle of arrival of the received signal.

19. The method of claim 18, wherein the estimation operation comprises:
a subtraction operation of obtaining a power subtraction value obtained by subtracting a power of the two signals; and
a calculation operation of comparing the subtraction value of the power obtained by the subtractor with a subtraction value between a radiation gain of an estimated angle of arrival and a radiation gain of an angle obtained by subtracting a subtraction angle from the estimated angle of arrival, and determining the angle of arrival of the signal received by the array antenna by using the estimated angle of arrival, when the subtraction value of the power obtained in the subtraction process is within a certain range.

20. The method of claim 18, wherein in the estimation operation, the radiation gain values regarding the entire range of the angle of arrival of the array antenna are previously calculated and stored as a database, and then used when the radiation gain is obtained.
